(19) United States
(12) Patent Application Publication
(10) Pub. No.: US 2017/0365191 A1
(43) Pub. Date: Dec. 21, 2017

(54) ITERATIVE ENCRYPTION AND RANDOM GENERATION AND SERIALIZATION OF CRYPTOGRAPHIC FUNCTIONS

(71) Applicant: Lior Malka, San Jose, CA (US)

(72) Inventor: Lior Malka, San Jose, CA (US)

(21) Appl. No.: 15/185,797

(22) Filed: Jun. 17, 2016

(51) Int. Cl. G09C 1/00; H04L 9/06

(52) U.S. Cl. CPC G09C 1/00; H04L 9/065; H04L 9/06; H04L 2209/72

(57) ABSTRACT

Cryptography provides a wide variety of functions. For example, encryption provides data confidentiality and signatures provide data integrity. In one embodiment, a plurality of encryption functions is iteratively applied to produce a ciphertext. In one embodiment, a data sequence describing a cryptographic function is processed by a reader who outputs the cryptographic function. The data sequence may be stored or transmitted and the cryptographic function may be used for cryptographic purposes. In another embodiment, a generator produces random cryptographic functions.

### BACKGROUND

Cryptography provides a wide variety of functions. For example, encryption provides data confidentiality and signatures provide data integrity. Cryptographic functions may be constructed from other functions which are either cryptographic or non-cryptographic in nature. Existing art does not show iterative encryption or methods for random generation or serialization of cryptographic functions. Serialization involves the formatting of data so that it can be transmitted or stored.

### SUMMARY

Embodiments are provided for encryption and for random generation and serialization of cryptographic functions. In one embodiment, encryption is applied iteratively to produce a ciphertext. Iterations use a different or an identical encryption, which may be selected randomly or from a user provided set, or both. In another embodiment, data is written into a sequence, which may be stored or transmitted over a network, and a reader extracts elements from the sequence to initialize a cryptographic function. The function may be encryption, signature, signcryption, or any other cryptographic function. In another embodiment, input is given to a generator that outputs a sequence using random values, and a reader initializes and outputs a random cryptographic function by reading elements from the sequence.

### DRAWINGS

The following figures illustrate the embodiments by way of example. They do not limit their scope.

FIG. 1 shows a flow diagram of a method of encryption, in accordance with one embodiment.

FIG. 2 shows a flow diagram of a method of initializing a cryptographic function from serialized data, in accordance with one embodiment.

FIG. 3 shows a flow diagram of a method of producing random cryptographic functions, in accordance with one embodiment.

### DETAILED DESCRIPTION

This section includes detailed examples, particular embodiments, and specific terminology. These are not meant to limit the scope. They are intended to provide clear and through understanding, cover alternatives, modifications, and equivalents.

In cryptography, encryption provides data confidentiality and signatures provide data integrity. Signcryption provides both. The complement of a cryptographic function is implicit. For example, encryption means either encryption or decryption, and signatures means either signatures or verification. A cryptographic function is symmetric if the same key is used by its complement. For example, AES (Advanced Encryption Standard) encryption and AES decryption use the same key. A cryptographic function has a key replacement if the key is modified during operation. For example, an encryption may select a new random key at a certain frequency, encrypt the new key using previous key, and replace previous key with new key. Alternatively, the key may be replaced using other strategies. A cryptographic composition is a cryptographic function constructed from one or more cryptographic functions. For example, a signcryption may be constructed from encryption and signatures

An object implemented using software or hardware can represent any logic, including encryption, signatures, signcryption, any cryptographic function and any cryptographic composition. Objects with similar functionality may have different implementations. For example, encryption may take a block (known as plaintext) as input and produce a block (known as ciphertext) as output, but in a stream based design, encryption takes a byte as input, and the bytes are buffered, encrypted, and written to an underlying stream. This example extends to signatures, signcryption, and other cryptographic functions.

Any object can be serialized. Serialization involves the formatting of data so that it can be transmitted or stored. The logic writing the data is called a writer and the logic reading the data is called a reader. The serialized data is called a sequence. A sequence may have a physical representation, such as a memory, a file, a network connection, and so on. The writer or the reader can be internal or external to the logic of the serialized object. The writer and the reader may be in physically different locations. The data may be prepended with a type. The type may be used to select or verify a reader. More than one reader may exist for a given type, and readers, even if referring to the same type, can output objects of any kind. Writers and readers can be recursive. For example, if object A contains object B, then the output of a writer for A may include the output of a writer for B, and a reader for A may use a reader for B.

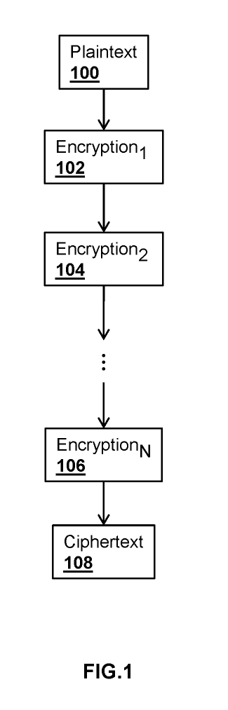

FIG. 1 shows a flow diagram of a method of encryption, in accordance with one embodiment. Input data, called plaintext 100, is provided as input to a first encryption function 102. The output of the first encryption function is provided as input to a second encryption function 104. A select number of iterations of applying encryption functions are performed, until a final encryption function 106 is applied. The output, called ciphertext 108, is produced by the final encryption function 106. The ciphertext can be decrypted by applying, in reverse order, the decryption functions corresponding to the encryption functions.

The encryption functions 102, 104, . . . , 106 may be selected randomly from a set of user defined encryption functions, may have a block or a stream implementation, may be symmetric or asymmetric, and may be identical or different. For example, some encryption functions may permute their input, while others may inject random bits into their input. Other functions, such as AES (Advanced Encryption Standard) comply with certain standards. At least one of the encryption functions may be selected from a set of certified encryption functions, and used at first, intermediate, or final iteration.

The encryption functions 102, 104, . . . , 106, their mode, their order, the number of iterations and repetitions can be adapted for different applications. For example, if the first encryption is a permutation, and the second encryption is AES in chained block cipher (CBC) mode, and the final encryption injects random bits, then the resulting encryption, when compared to AES in CBC mode, complies with the same standards and consumes slightly more computational resources.

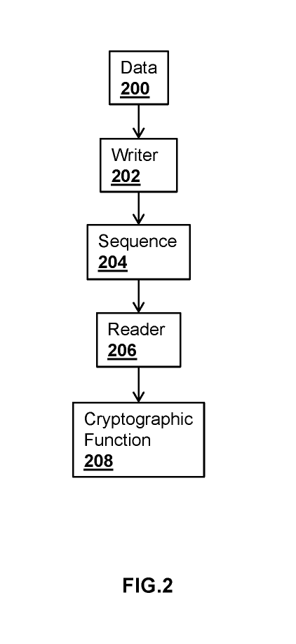

FIG. 2 shows a flow diagram of a method of initializing a cryptographic function from serialized data, in accordance with one embodiment. Input data 200 is provided to a writer 202 of a given type. The writer outputs a sequence 204 containing the type followed by the data. For example, the type may be “keyed SHA2”, representing the hash function SHA2, and the data may be an array of bytes representing a key. Alternatively, the type may represent a cryptographic composition, and the data may represent components of the cryptographic composition. For example, if the composition is a plurality of encryption functions, then the data may describe each encryption function from the a plurality of encryption functions. As another example, if the composition is an encryption and a signature, then the data may describe the encryption and the signature.

A reader 206 for the type reads the data and outputs a cryptographic function 208 initialized with the data. For example, a reader for keyed SHA2 may read an array of bytes representing a key, and output a SHA2 hash function initialized to produce signatures using the key. Any reader for the type can be used. For example, the reader may output a SHA2 verification function that, given a message and a signature, verifies that the signature matches the message when signed with SHA2 with the key.

The input data may include elements of different types and may be further processed by the writer. For example, if the data includes an encryption function and a byte array representing a key for the encryption function, then the writer may use the encryption function to determine the length of the key, and the length may be written into the sequence along with the key.

The writer and the reader may be operated on physically different devices, by different entities, and at different times.

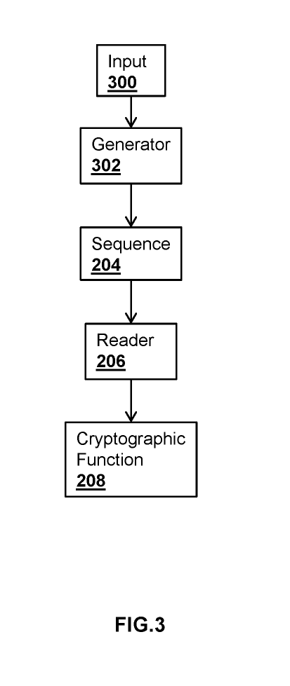

FIG. 3 shows a flow diagram of a method of producing random cryptographic functions, in accordance with one embodiment. Input 300 is given to a generator 302 for a given type of a cryptographic function. The generator generates a sequence 204. The generator 302 may use random values and may be invoked repeatedly to generate a plurality of sequences. A reader 206 for the type uses the sequence to initialize and output the cryptographic function 208.

For example, if the input includes a set of keyed signatures, such as keyed SHA1 and keyed SHA2, and the generator selects keyed SHA1 as the signature and a random byte array as the key for the keyed SHA1, then the reader would output a keyed SHA1 initialized with the key.

The generator may use other generators. For example, a generator for a signcryption may use an encryption generator and a signature generator. As another example, a generator for iterative encryption may use a random number generator to select the iteration number and then use an encryption generator to generate the number of encryption functions.

The specific embodiments and specific terminology used above should not be construed as limiting the scope of the embodiments. These details have been presented for purposes of illustration and are not intended to be exhaustive. Many modifications and uses are possible. The scope of the embodiments is defined by the Claims appended hereto and their equivalents.

What is claimed is:

1. A method of encryption, the method comprising:
receiving a plaintext as input; and
iteratively applying a select encryption function from a plurality of encryption functions; and
computing a ciphertext from final iteration; and
outputting the ciphertext.

2. The Method of claim 1, wherein the plurality of encryption functions is selected randomly from a set of user defined encryption functions.

3. The Method of claim 1, wherein the number of iterations is selected randomly from a user defined range.

4. The Method of claim 1, wherein iteratively applying a select encryption function further includes applying, at an intermediate iteration, an encryption function selected from a set of certified encryption functions.

5. The Method of claim 1, wherein the encryption function is implemented as a stream.

6. The Method of claim 1, wherein the encryption function is symmetric or asymmetric.

7. The Method of claim 1, wherein at least one encryption function has key replacement.

8. A method of initializing a cryptographic function from serialized data, the method comprising:
receiving input containing data; and
writing the input into a sequence; and
reading elements from the sequence; and
using the elements to initialize a cryptographic function;
and outputting the cryptographic function.

9. The method of claim 8, wherein the sequence is a memory or a file or a network connection.

10. The method of claim 8, wherein the writing is performed on a first device and the reading is performed on a second device.

11. The method of claim 8, further comprising applying the cryptographic function to an input to obtain an output.

12. A method of producing random cryptographic functions, the method comprising:
receiving input; and
generating a sequence from the input using random values; and
reading elements from the sequence to initialize a cryptographic function; and
outputting the cryptographic function.

13. The method of claim 12, wherein the cryptographic function is an encryption or a signature or a signcryption.

14. The method of claim 12, wherein the cryptographic function is an iterative encryption.

15. The method of claim 12, wherein the sequence is written to a file or a network connection.

16. The method of claim 12, wherein generating a sequence from the input using random values is performed on a first device and the reading is performed on a second device.
